(19) United States
(12) Patent Application Publication
(10) Pub. No.: US 2004/0200143 A1
(43) Pub. Date: Oct. 14, 2004

(54) Plant collar and support system

(76) Inventor: Elizabeth Stanley, Windsor, CT (US)

Correspondence Address: INTELLECTUAL PROPERTY ADVISORS LLC, PO BOX 156, CANTON, CT, 06019, US

(21) Appl. No.: 10/786,146

(22) Filed: Feb. 24, 2004

Related U.S. Application Data
(60) Provisional application No. 60/449,336, filed on Feb. 24, 2003.

(51) Int. Cl. A01G 17/06

(52) U.S. Cl. 47/44

(57) ABSTRACT

A plant collar support and containment system for the growing and supporting plants and preventing the onset of diseases and rotting by supporting a plant\.

This application claims the benefit of U.S. Provisional Patent Application No. 60/449,336 filed Feb. 24, 2003.

### BACKGROUND OF THE INVENTION

1. Field of the Invention

The present invention relates generally to systems and devices for growing and supporting plants and, more particularly, to a plant container and support configured to protect the plant and improve plant health.

2. Description of the Related Art

It is well known various plants require support systems in order to grow and flourish. Various plant containers such as flower pots, window boxes and the like are configured to contain dirt in an enclosure with one open end, or simply sidewalls and a bottom, so as to grow a plant. The primary benefit of a pot is to contain dirt, however, conventional pot or container designs do not support or contain the plant and other have disadvantages of stability or tipping as plants grow larger. Moreover, conventional containers designs are not split or otherwise configured to be placed around an already existing plant or to provide benefits of protection for sprouting and or out bloom plants in the garden.

One of the know methods is a stake for supporting growing and confining vegetation. The conventional designs are replete with staking and trellis support structures of a myriad of designs and applications with protectile coverings for frost and other adverse conditions. Some staking devices utilize a cage structure formed from poles, wire or mesh that implements various means of making the support system adjustable, foldable or the like for off season disassembly and reassembly. For example, U.S. Pat. No. 6,088,956 discloses a foldable, plant stake or support device utilizing metal rods and circular hoops attached to the rods to form a cage as well as a protective barrier to be secured to the cage. U.S. Pat. No. 5,913,477 discloses a combined support and irrigation system. U.S. Pat. No. 5,826,375 discloses a modular trough system for plants that can be arranged in several configurations. U.S. Pat. No. 5,711,107 discloses a modular support rod-like system for plants that can be arranged in several configurations. U.S. Pat. No. 5,349,780 discloses a plant stake or support device with easy attachment portions for securing a plant stem and or fencing to the ribs of the stake. Similarly, U.S. Pat. No. 4,860,489 discloses an adjustable plant cage and support having posts, a plastic coil and clamps for attaching the coil to the posts; the plastic cage is adjustable cage for confining a plant and for elongating the cage by moving the clamps affixed to the posts to stretch the coil on the posts. U.S. Pat. No. 4,785,576 also discloses triangular a pole and cage system that can be arranged into hexagonal pods. U.S. Pat. No. 4,752,341 also discloses a radial a pole and trellis system that can be arranged into hexagonal pods. U.S. Pat. No. 5,063,709 discloses a trellis support device for creating a vine canopy that can be fastened to existing wood or metal grape stakes. U.S. Patent No. Des. 406,021 and Des. 411,722 discloses a foldable, plant stake or support device utilizing metal rods and circular hoops attached to the rods to form a cage.

It also is well known in the agricultural arts that careful attention to the soil, air and water improves plants ability to grow and flourish. For example, U.S. Pat. Nos. 5,094,029 and 4,255,898 disclose a trough system for separating service and growing channels to maximize the large scale growing of plants. U.S. Pat. No. 4,888,912 discloses agricultural envelop structure to create a structure for aquatic plants. U.S. Pat. No. 4,231,187 discloses large scale agricultural structure to separate and hydrophilic columns for a plant support system that can be arranged on a base and support having a permeable floor forming thereby a column to enhance the use of air and water. U.S. Pat. No. 4,178,715 discloses a large scale channel culture array configured as a V-shaped channel that can be arranged in a side-by-side relationship for maintaining the soil in which a plant is growing in a wetted condition using saline water, whereby the saline water does not contact the soil. Similarly, U.S. Pat. No. 4,107,876 discloses an inverted V-Channel floor of a planter for large scale operations to improve water and nutrient transfer to the soil packed on the channel floor.

However, the support structures consisting of wire, mesh and coil do not present an attractive appearance for the home gardener and applicable to large scale agricultural endeavors. Other prior art structures do not address creating a barrier to holding all foliage and flowers off of the earth to prevent the plant from becoming infected, rotten or uprooted. It is therefore an object of the present invention to improve on the prior art structures as is advantageously provided by the plant collar of the present invention.

### SUMMARY OF THE INVENTION

[Insert Final Versions of Broadest System and Apparatus claims as Last Step]

### DESCRIPTION OF THE DRAWINGS

These and other advantages of the present invention are best understood with reference to the drawings, in which:

FIG. 1 is a perspective view of the collar and support system of the present invention;

FIG. 2 is a top view of the collar;

FIG. 3 is a bottom view of the collar;

FIG. 4 is a side view of the collar, which because the collar has a largely circular design, illustrates additional front and back views;

FIG. 5 is a schematic diagram of the two halves of the collar according to the cutaway lines of FIG. 4; and

FIG. 6 illustrates decorative hardware and its attachment to the collar according to an embodiment of the present invention.

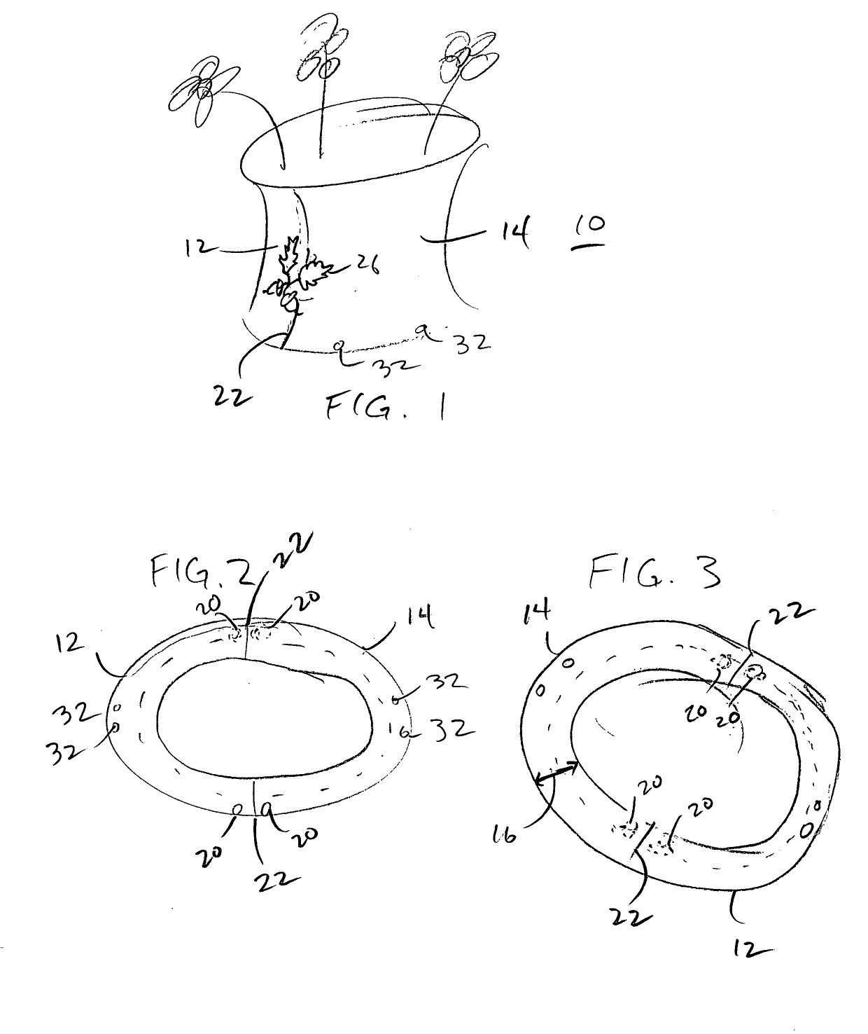

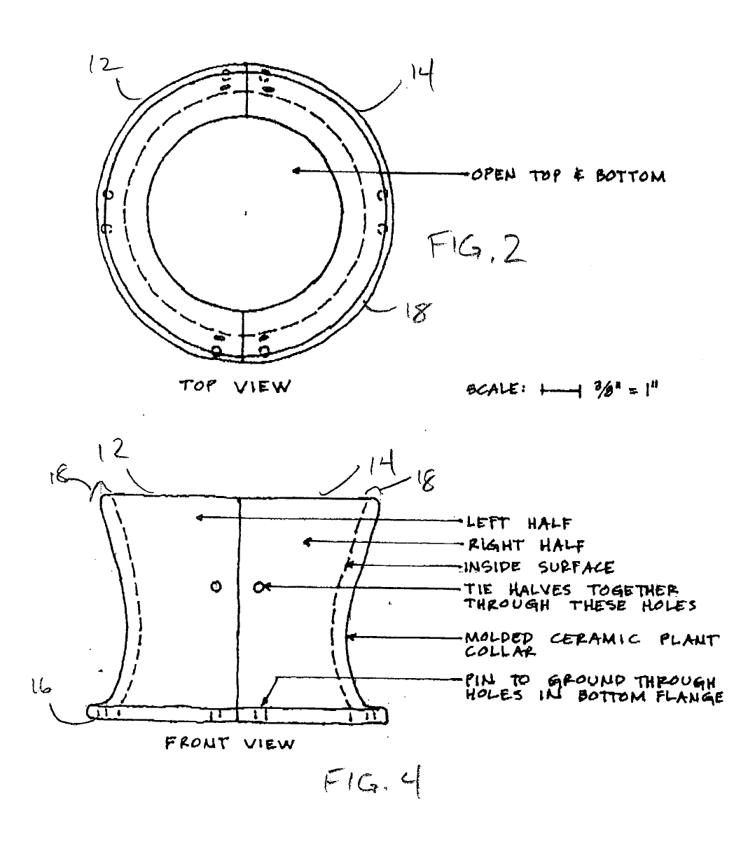

### DETAILED DESCRIPTION OF THE PREFERRED EMBODIMENT

Referring to FIG. 1, according to an embodiment of the present invention, the collar and support system 10 is illustrated. As is described here, the term “plant collar” refers to a container suitable for protecting, shading, housing, and supporting at least one or more bulbs, perennials, annuals, vines, shrubs, vegetables, and trees. While the specific construction of the plant collar and support system in this exemplary embodiment describes a clay collar, other combinations of materials and shapes are useful in making the invention in a decorative, cost-effective manner.

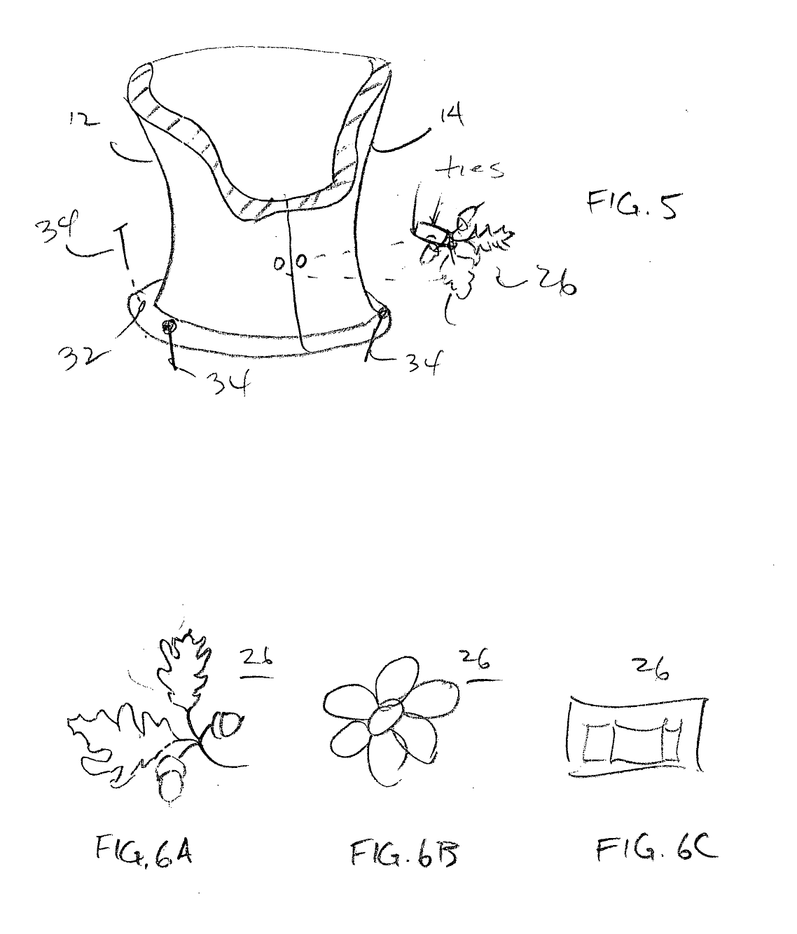

The collar and support system 10 is configured having a generally cylindrical shape with side portions 12 and 14. Each of the side portions 12 and 14 have a lower flange 16 forming a base configured to rest on the ground or to otherwise provide a stable base to rest on. Side portions 12 and 14 also include an upper edge 18 configured to be smooth as this edge will engage and adaptively support the plant or other vegetation that the collar is put around. Each of the side portions further has holes 20 formed in the side portions 12 and 14 along an edge 22 that are configured to secure together the two halves of the side portions 12 and 14 using a fastener 24. The fastener 24 can be standard hardware construction such as a twist tie, plastic cable tie or other common hardware such as wire, bolts and the like. The collar and support system 10 also can have decorative caps, for example, an oak leaf and acorn cap design 26 as is shown in FIGS. 1 and 6A, and likewise, a flower cap design 28 and a buckle cap design 30, as is shown in FIGS. 6B and 6C. The decorative cap 26 can be used with the fastener 24 to close through holes 20 formed in side portions 12 and 14 so as to hide the holes 20 decoratively. Furthermore, the flange 16 of side portions 12 and 14 is configured to include holes 32 for a fastener 34 such as a wooden stake to secure the collar at the base to the ground.

The side portions 12 and 14 can be formed of a unitary construction or advantageously in two or more parts so that the collar can be placed around an existing plant without damage. A unitary construction can be useful when at a time of initial planting or transplanting. Two or more sections can be made detachable such as, for example, in half-portions, in a clamshell, or in other dimensions such as ⅓ and 2/3 sections, or in a quarter ¼ and ¾ sections. Such non-symetrical side portions can locate a smooth decorative side at a desired viewing perspective.

For example, when the side portions 12 are formed in halves, each a mirror image of the other, the line of connection between halves further include tie holes 14 and 16 for securing the halves together by rope, twist ties, cable ties and the like as is described herein.

Although exemplary embodiments of the present invention have been shown and described with reference to particular embodiments and applications thereof, it will be apparent to those having ordinary skill in the art that a number of changes, modifications, or alterations to the invention as described herein may be made, none of which depart from the spirit or scope of the present invention. For example, the material for the collar and support system can use other combinations of lightweight durable materials. Also while the arcuate shape is attractive, other shapes can be molded to the exterior surface while keeping the interior surface smooth to not damage the plant. All such changes, modifications, and alterations should therefore be seen as being within the scope of the present invention.

I claim:

1. A plant support and container, comprising:
an enclosure generally cylindrical and having open ends and side portions, each side portion being configured to accept and surround a plant, the side portions being secured by means to keep the side portions in place so as to support the plant.
